(19) United States
(12) Patent Application Publication
(10) Pub. No.: US 2005/0051529 A1
(43) Pub. Date: Mar. 10, 2005

(54) Cooking device with smoke and odor abatement

(75) Inventors: William Day, New Port Richey, FL (US); Dave Harter, New Port Richey, FL (US); Jan Claesson, New Port Richey, FL (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: ENODIDS CORPORATION

(21) Appl. No.: 10/846,346

(22) Filed: May 14, 2004

Related U.S. Application Data
(60) Provisional application No. 60/470,818, filed on May 15, 2003.

(51) Int. Cl. H05B 1/02; A21B 1/22

(52) U.S. Cl. 219/400; 219/494

(57) ABSTRACT

A cooking device and method for removal of contaminants from an air stream that circulates in the cooking device. The cooking device includes a fan that operates to circulate the air stream in a path that includes a cooking chamber and a heating chamber of the cooking device. A catalytic material is disposed on one or more surfaces of a structure that is disposed in close proximity to the fan, such as about the periphery of the fan. The structure may include honeycomb, laminar or finned arrangements.

### CROSS REFERENCE TO RELATED APPLICATION

This application claims the benefit of U.S. provisional application 60/470,818, filed on May 15, 2003, the entire contents of which are hereby incorporated by reference.

### FIELD OF THE INVENTION

This invention relates to cooking devices and, more particularly, to a cooking device with abatement of contaminates, such as grease, smoke and odor.

### BACKGROUND OF THE INVENTION

Cooking devices have employed catalytic converters for removal of contaminants from a circulating hot air stream in a cooking device. The contaminants include grease, smoke and other undesired particles that can cause an odor. The catalytic converter flamelessly oxidizes oxidizable components of the contaminants in the circulating hot air stream. Due to the size of known catalytic converters, the ductwork of the cooking device had to be enlarged to accommodate the catalytic converters. This has resulted in larger footprints of the cooking devices.

Thus, there is a need for a cooking device that has a catalytic converter and that has a relatively small footprint.

### SUMMARY OF THE INVENTION

The cooking device of the present invention fulfills the aforementioned need with a catalytic material that is disposed in close proximity to a fan that circulates the air stream in a fluid communication path that includes a cooking chamber and a heating chamber. By locating the catalytic material in close proximity to the fan, instead of in the ductwork, the ductwork can be smaller, thereby allowing a smaller footprint for the cooking device.

In one embodiment of the cooking device of the present invention, the catalytic material is disposed about the periphery of the fan. In other embodiments, the fluid path extends between the cooking chamber and the heating chamber via a side, a top, a bottom or a back of the cooking chamber.

In other embodiments of the cooking device of the present invention, the catalytic structure is comprised of a honeycomb arrangement, a laminar arrangement a fin arrangement or an arrangement of a plurality of air passages disposed in a plurality of layers.

In another embodiment of the cooking device of the present invention, the catalytic structure comprises

In another embodiment of the cooking device of the present invention, the heater element is elongated and includes a plurality of fins that extend outwardly. The catalytic material is disposed on the heater element. Preferably, the heater element is shaped to extend about the periphery of the fan.

In another embodiment of the cooking device of the present invention, the catalytic structure comprises a plurality of layers that are separated by air gaps. Each of the layers includes a heater element with the catalytic material being disposed on at least one side of the heating element so as to face one of the air gaps. The circulating air stream flows through the air gaps and is cleansed of contaminants by the catalytic material.

In another embodiment of the cooking device of the present invention, the catalytic material is also disposed on an opposed side of the heating elements of the layers. In some embodiments, each of the layers further includes a metallic plate disposed between the at least one side of the heater element and the catalytic material. In further embodiments, the catalytic material is also disposed on an opposed side of the heater elements.

In another embodiment of the cooking device of the present invention, the catalytic material is disposed on at least one blade of the fan.

In another embodiment of the cooking device of the present invention, the catalytic material is disposed on a fan cover so as to contact the air stream being taken in be the fan.

The method of the present invention operates a fan to circulate the air stream in a cooking device. A catalytic material is disposed in close proximity to the fan to remove the contaminants from the air stream.

In another embodiment of the method of the present invention, the catalytic material is disposed on a structure that is positioned substantially in a radial flow of the air stream emitted by the fan.

In another embodiment of the method of the present invention, the catalytic structure is located about a periphery of the fan.

In another embodiment of the method of the present invention, the catalytic structure comprises a plurality of layers that are arranged in a laminar arrangement with air gaps between the layers, the air gaps being substantially aligned with the radial flow. The catalytic material is disposed on at least one surface of the layers.

In another embodiment of the method of the present invention, the catalytic structure comprises a honeycomb arrangement that includes surfaces that define a plurality of air passages that are substantially aligned with the radial flow. The catalytic material is disposed on the surfaces.

In another embodiment of the method of the present invention, the air stream is heated.

In another embodiment of the method of the present invention, the air stream circulates in a path that extends through a cooking chamber and a heating chamber of the cooking device. The fan and the catalytic material are disposed in the heating chamber.

In another embodiment of the method of the present invention, the catalytic material is disposed on at least one blade of the fan.

In another embodiment of the method of the present invention, the catalytic material is disposed on a fan cover so as to contact the air stream being taken in by the fan.

In the various embodiments of the cooking device and method of the present invention, heated air makes multiple passes across and through the catalytic structure, thereby cleaning the air of smoke and odors during the cooking process. The multiple pass system has several advantages vis-à-vis a traditional single pass system. The multiple pass system can operate at lower temperatures, thereby providing better baking performance without serious disruption from higher operating temperatures as well as increasing the efficiency. The multiple pass system also allows the catalyst surface area to have a small enough footprint to be disposed in the heating chambers of convection ovens, instead of in a remote area of the oven ductwork.

The continuous cleaning of the heated air during the cooking process reduces or eliminates the puff of smoke when the cooking device door is opened to remove a cooked food product. This allows the cooking device to be used in locations, such as convenience stores, that do not have an exhaust system for exhausting smoke and other contaminants to the outside. This further allows the cooking device, when installed in exhaust free locations, to cook items, such as meatloaf, that produce smoke and other contaminants. In several of the embodiments the combination heater/catalyst is disposed in the exhaust air of the fan.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a perspective view of the cooking device of the present invention;

FIG. 2 is a perspective view of the cooking device of FIG. 1 with the heating chamber exploded from the cooking chamber;

FIG. 3 is a perspective view from another angle of the exploded heating chamber of FIG. 2;

FIG. 4 is a cross-sectional view of an alternate embodiment of the heater/catalyst structure of the cooking device of FIG. 1;

FIG. 5 is a perspective view of an alternate embodiment of the fan assembly for the heater chamber of FIG. 1;

FIGS. 6-8 are cross-sectional views of alternate embodiments of the heater/catalytic structure of FIG. 5;

FIG. 9 is a perspective view of the oven of FIG. 1 with top and side covers in phantom showing the fan assembly of FIG. 5 installed;

FIG. 10 is a perspective view of an alternate embodiment of the heater/and catalyst structure for the cooking device embodiments of the present invention;

FIG. 11 is a perspective view of another cooking device embodiment of the present invention;

FIG. 12 is a top view of FIG. 11;

FIG. 13 is a perspective view of the fan cover of FIG. 11; and

FIG. 14 is a perspective view of a blade of the fan of FIG. 3 or FIG. 11.

### DESCRIPTION OF THE PREFERRED EMBODIMENT

The cooking device of the present invention includes a circulating air stream that is generated by a fan. Cooking devices of this type, for example, include convection ovens, combination microwave/convection ovens, conveyor ovens and the like. In some cooking devices of the present invention, the ductwork can be arranged to provide columns of impingement air. Also, moisture may be imparted into the air stream. By way of example, the cooking device of the present invention will be described herein in the context of a convection oven.

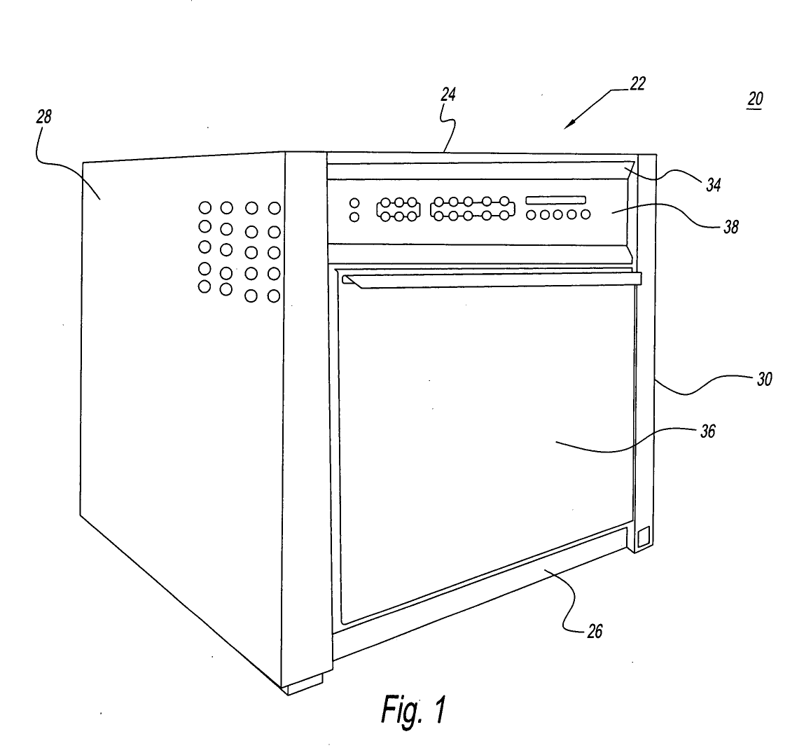

Referring to FIG. 1, an oven 20 of the present invention includes a housing 22 that has a top panel 24, a bottom panel 26, a side panel 28, a side panel 30, a back panel 32 and a front panel 34. A door 36 is mounted to front panel 34 so as to pivot about a fulcrum (not shown) near bottom panel 26 so as to operate as a drop down door. A control section 38 is mounted in front panel 34 above door 36.

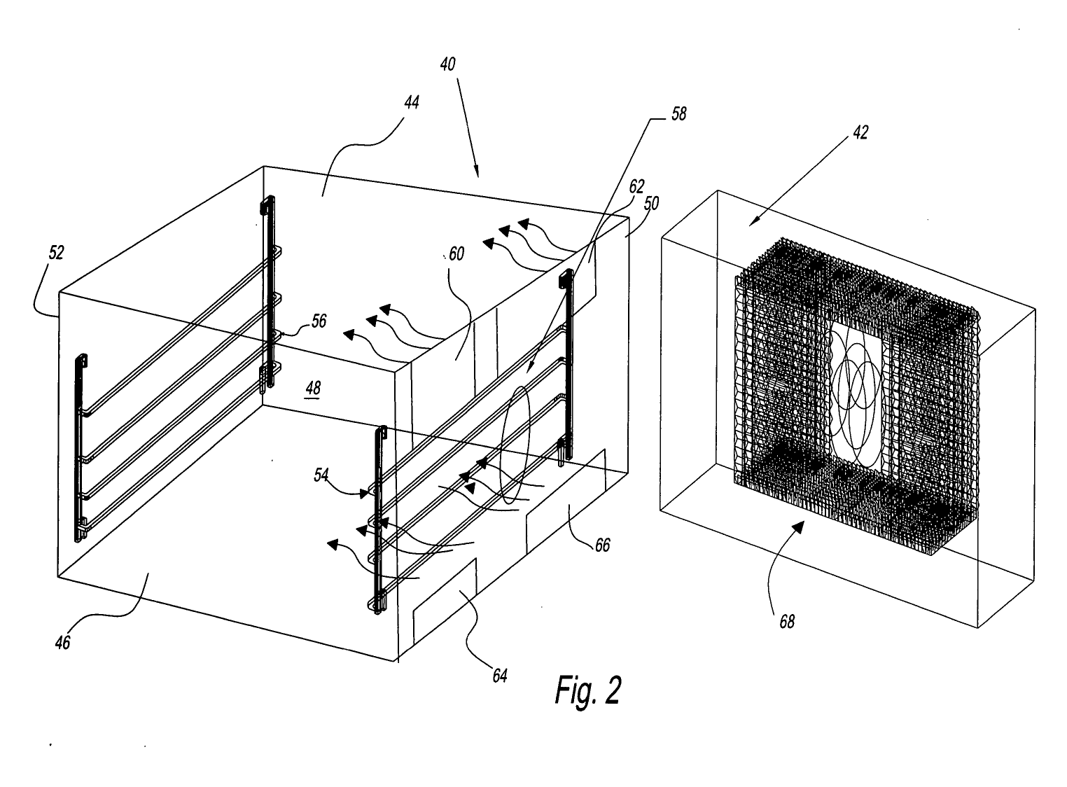

Referring to FIG. 2, a cooking chamber 40 and a heating chamber 42 are shown disassembled from housing 22. When assembled, cooking chamber 40 and heating chamber 42 are mounted to housing 22 by fasteners and/or supports (not shown). Cooking chamber 40 includes a top 44, a bottom 46, a back 48, a side 50 and a side 52. Shelf supports 54 and 56 are mounted on sides 50 and 52, respectively, for holding shelves or racks (not shown) upon which food may be disposed for cooking. Side 50 includes an air intake port 58 located about in the center thereof. Air exhaust ports 60 and 62 are disposed above and offset laterally from intake port 58 and air exhaust ports 64 and 66 are disposed below and offset laterally from intake port 58.

Heating chamber 42 is preferably shaped to mate with side 50 of cooking chamber 40, when assembled thereto by fasteners (not shown). In the embodiment shown in FIG. 2, both side 50 and heating chamber 42 have a rectangular shape, but may have other desired shapes. Heating chamber 42 includes a fan assembly 68 mounted thereto.

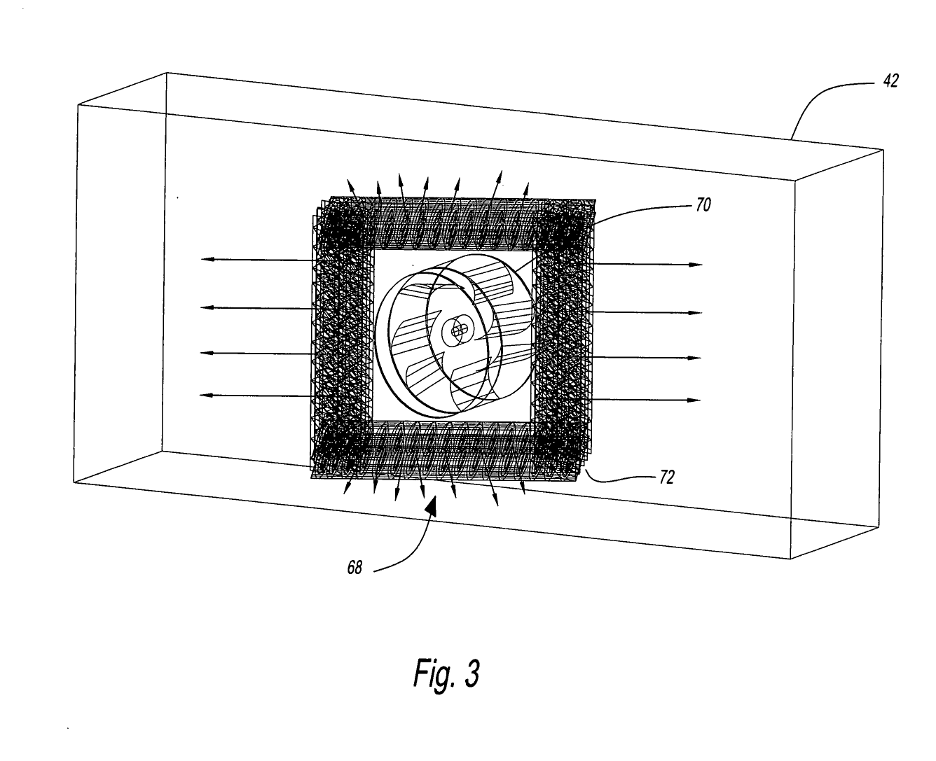

Referring to FIG. 3, fan assembly 68 includes a fan 70. A heater/catalyst structure 72 is disposed about the periphery or circumference of fan 70. Fan 70 draws air from within cooking chamber 40 via air intake port 58 into heating chamber 42. The air is heated and cleansed of odor and smoke by heater/catalyst structure 72 and then returned to cooking chamber 40 via air exhaust ports 60, 62, 64 and 66. That is, fan 70 provides a stream of heated air that circulates through cooking chamber 40 and heating chamber 42 via air intake port 58 and air exhaust ports 60, 62, 64 and 66.

Although oven 20 is shown as a convection oven, it will be apparent to those skilled in the art that oven 20 may alternatively be a structure convection and microwave oven with the microwave energy being supplied to cooking chamber 40 from top 44, bottom 46, back 48, and/or side 52. It will also be apparent to those skilled in the art that heating chamber, air intake port 58 and air exhaust ports alternatively may be disposed to provide the circulating air to cooking chamber 40 via side 52, top 44, bottom 46 or back 48.

Fan 70 may suitably be a blower wheel that takes in air along its axis and expels air via its circumferential periphery. For example, fan 70 may be a forward incline, backward incline or radial fan. The expelled air travels through heater/catalyst structure 72, which removes smoke and other contaminants from and heats the air stream upstream of air exhaust ports 60, 62, 64 and 66.

Heater/catalyst structure 72 may have any suitable shape, such as rectangular (as shown in FIGS. 2 and 3), polygonal, square, circular, oval and the like. In the embodiment shown in FIGS. 2 and 3, heater/catalyst structure 72 has a honeycomb structure that contains a large plurality of air passages therethrough.

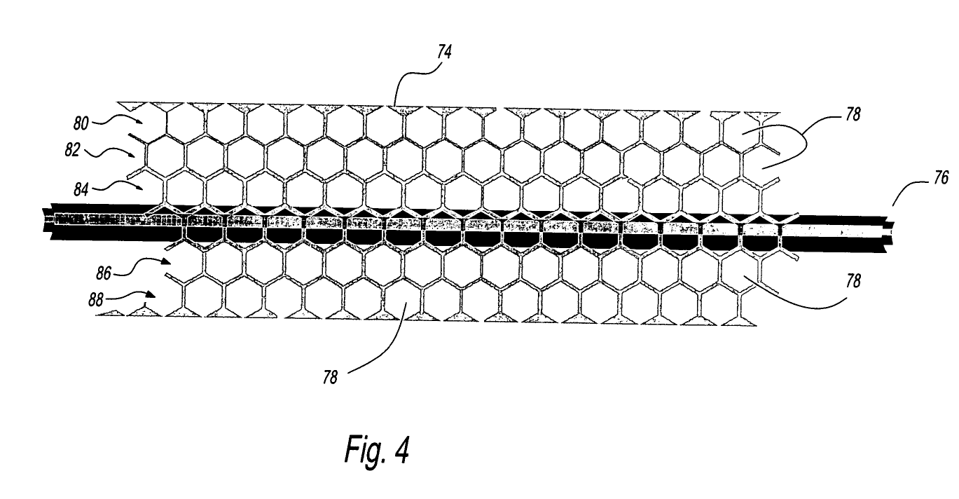

Referring to FIG. 4, one embodiment of heater/catalyst structure 72 comprises a honeycomb structure 74 that contains a catalyst coating with a heater element 76 disposed within honeycomb structure 74. Honeycomb structure 74 is formed of a metal or ceramic monolith coated with a catalytic material, which, for example, may be palladium, platinum, a combination thereof, or an alloy thereof.

Honeycomb structure 72 comprises a relatively large plurality of air passages 78, each coated with a catalytic material. Air passages 78 are arranged in a plurality of layered rows 80, 82, 84, 86 and 88. To form honeycomb structure 72, adjacent rows are offset from one another and alternate rows are aligned with one another. For example, air passages 78 of adjacent rows 80 and 82 are offset from one another and air passages of alternate rows 80 and 84 are aligned with one another. Air passages 78 preferably have a hexagonal shape, but other shapes may be used, such as square, rectangular, polygonal, circular, oval, triangular, and the like. It will be apparent to those skilled in the art that layered structures other than honeycomb are possible to provide a large number of catalytic coated air passages 78. In all these embodiments, the large number of catalytic coated air passages provide a large catalytic coated surface area to the air stream, which enhances the removal of odor, smoke and contaminants from the air stream.

Heater element 76 extends along and is adjacent to row 84. Heater element 76 may be any suitable electrical heater element for heating the air stream and honeycomb structure 74.

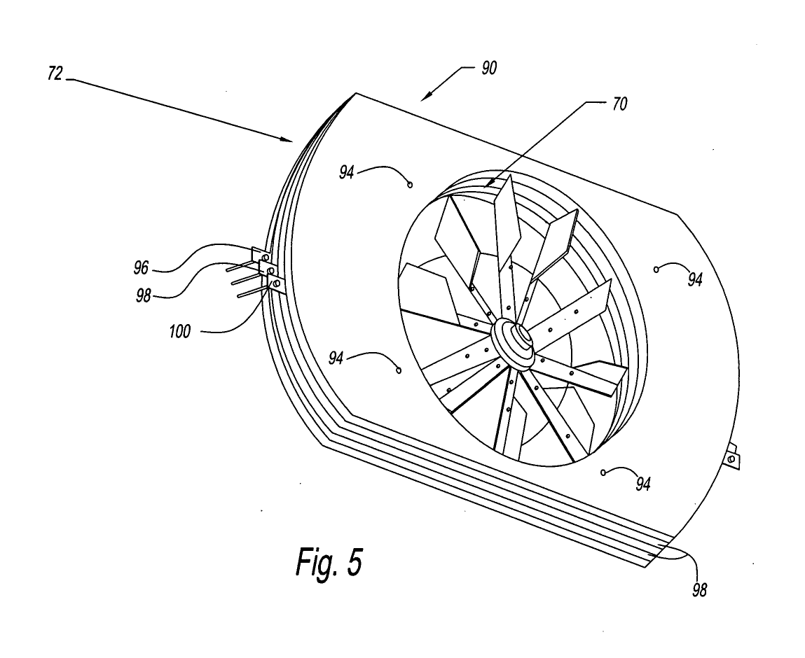

Referring to FIG. 5, another embodiment of heater/catalyst structure 72 includes a laminar structure 90 that has air gaps 92 between adjacent layers and that is shaped to surround the periphery of fan 70. The layers include heating elements, and/or catalytic elements. As fan 70 rotates, air is taken in from cooking chamber 40 via air intake port 58 and expelled radially through air gaps 92. The air stream is heated by the heater elements and decontaminated by the catalytic elements. Individual electrical contacts 96, 98 and 100 connect the heater elements in circuit with a source of electric energy (not shown). Fan 70 is shown in FIG. 5, by way of example, as a radial fan.

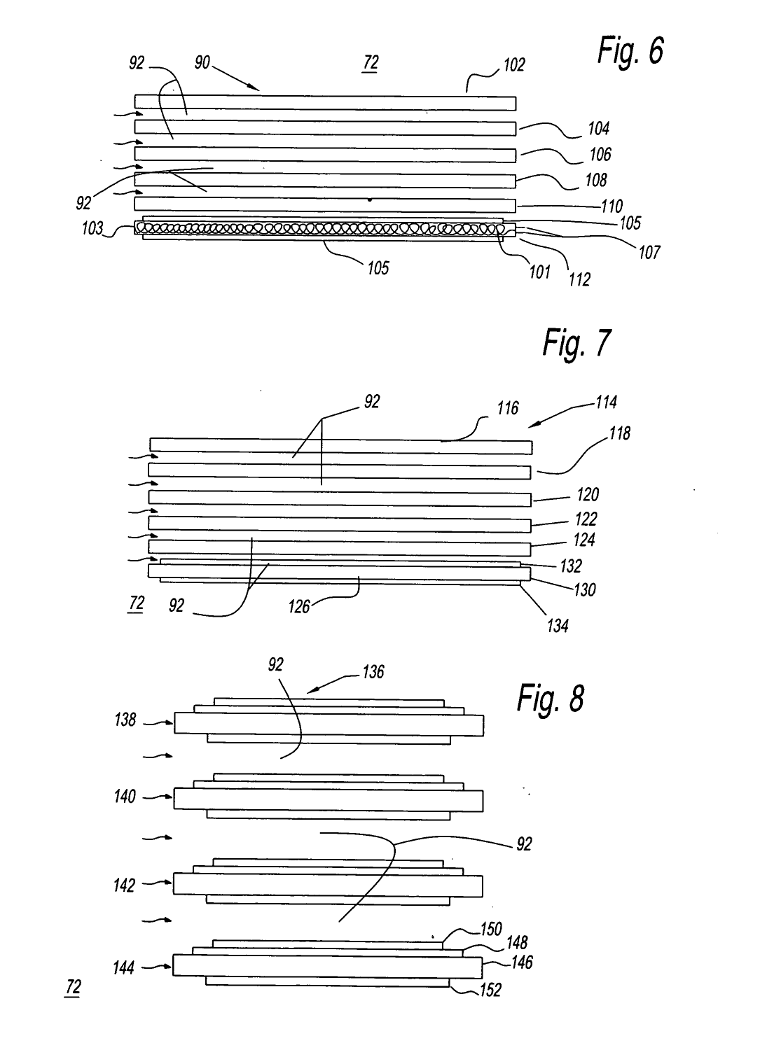

Referring to FIG. 6, one embodiment of heater/catalyst structure 72 of FIG. 5 may be formed of laminar structure 90 that includes a plurality of layers 102, 104, 106, 108, 110 and 112 with air gaps 92 disposed between adjacent layers. Each layer is substantially identical so only layer 112 will be described in detail. Layer 112 includes an electrical heater element 101 disposed in a box 103. Heater element 101 has a pair of electrical contacts 107 that extend externally of box 103. Catalytic layers 105 are disposed on opposite sides of box 103. Heater element 101 may be any suitable electrical heating element, such as a coil, strip element and the like. Box 103 may be constructed of metallic sheet material, such as stainless steel, aluminum and the like. Each catalytic layer 105 may be formed of a sheet of catalytic material, which, for example, may be palladium, platinum, a combination thereof, or an alloy thereof.

Referring to FIG. 7, another embodiment of heater/catalyst structure 72 may be formed of a laminar structure 114 of layers 116, 118, 120, 122, 124 and 126 that are separated by air gaps 92. Each layer is substantially identical so only layer 126 will be described in detail. Layer 126 includes a metal plate 130, a heater element layer 132 disposed on one surface of metal plate 130 and a catalytic element layer 134 disposed on the opposed surface of metal plate 130. Metal plate 130 may be any good electrical conductivity material, such as stainless steel. Heating element layer 132 may be any suitable electrical resistive heating element material. Catalytic element layer 134 may be any suitable catalytic material, which, for example, may be palladium, platinum, a combination thereof, or an alloy thereof.

Referring to FIG. 8, another embodiment of heater/catalyst structure 72 may be formed of a laminar structure 136 of layers 138, 140, 142 and 144 that are separated by air gaps 92. Each layer is substantially identical so only layer 144 will be described in detail. Layer 144 includes a metal plate 146, a heater element layer 148 disposed on one surface of metal plate 146 and a catalytic element layer 152 disposed on the opposed surface of metal plate 146. An additional catalytic element layer 150 is disposed on top of heater element layer 148. Metal plate 146 may be any good electrical conductivity material, such as stainless steel. Heating element layer 148 may be any suitable electrical resistive heating element material. Catalytic element layers 150 and 152 may be any suitable catalytic material, which, for example, may be palladium, platinum, a combination thereof, or an alloy thereof.

Referring to FIGS. 5-8, laminar structures 90, 114 and 136 are held together by fasteners 94 that, for example, extend through layers 102, 104, 106, 108, 110 and 112 of laminar structure 90 (FIG. 6). Fasteners 94 may be any suitable fasteners and may, for example, be bolts with spacers that separate the laminar sheets so as to provide air gaps 92.

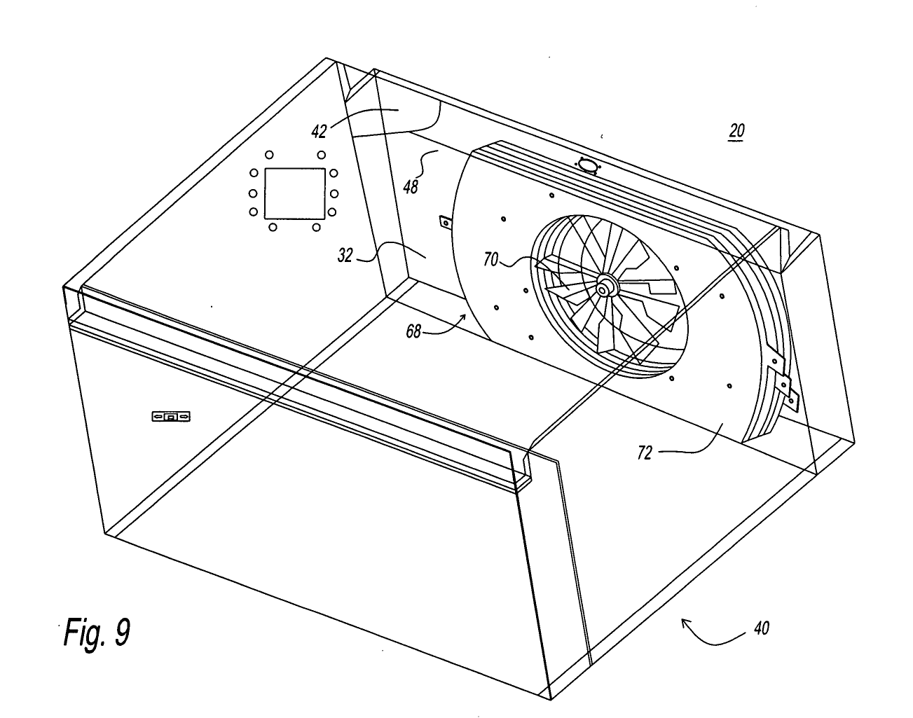

Referring to FIG. 9, cooking chamber 40 is shown with a portion of back 48 cut away. Thus, heating chamber 42 is located between back 48 of cooking chamber 40 and back panel 32 of oven 20. Fan assembly 68 is shown installed in heating chamber 42. Fan assembly 48 includes combination heater/catalyst 72 with the laminar structure of FIG. 5 that surrounds the periphery of fan 70. Fan 72 is aligned with an air intake port (not shown) disposed in about the center of back 48 of cooking chamber 40. The laminar structure may be any of the laminar structures shown in FIGS. 6-8.

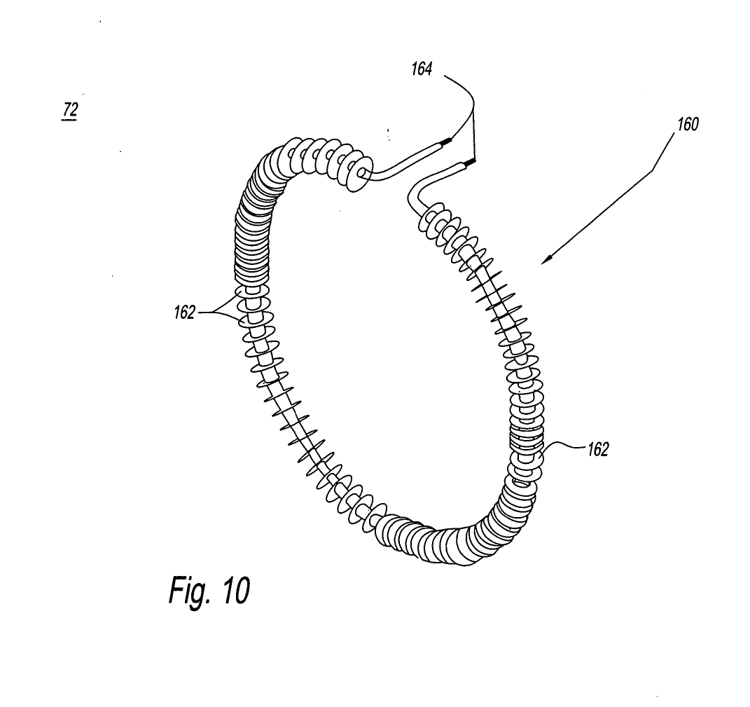

Referring to FIG. 10, another embodiment of heater/catalyst structure 72 comprises an electrical heater element 160. Heater element 160 has a plurality of fins 162 extending radially therefrom and disposed along its length at spaced apart locations. Heater element 162 is shaped for disposition around the periphery or circumference of fan 70. For example, heater element 160 is shown as substantially circular, but may have other shapes as mentioned above for heater/catalyst structure 72. Heater element 160 and fins 162 are covered with a coating of catalytic material. Electrical contacts 164 are electrically connected to each end of heater element 160.

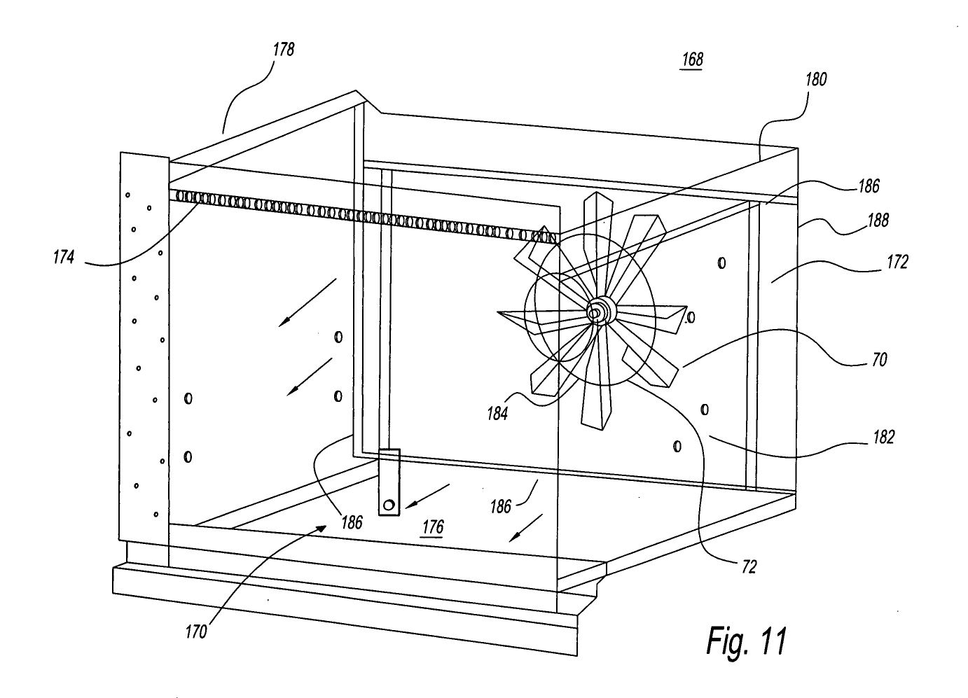

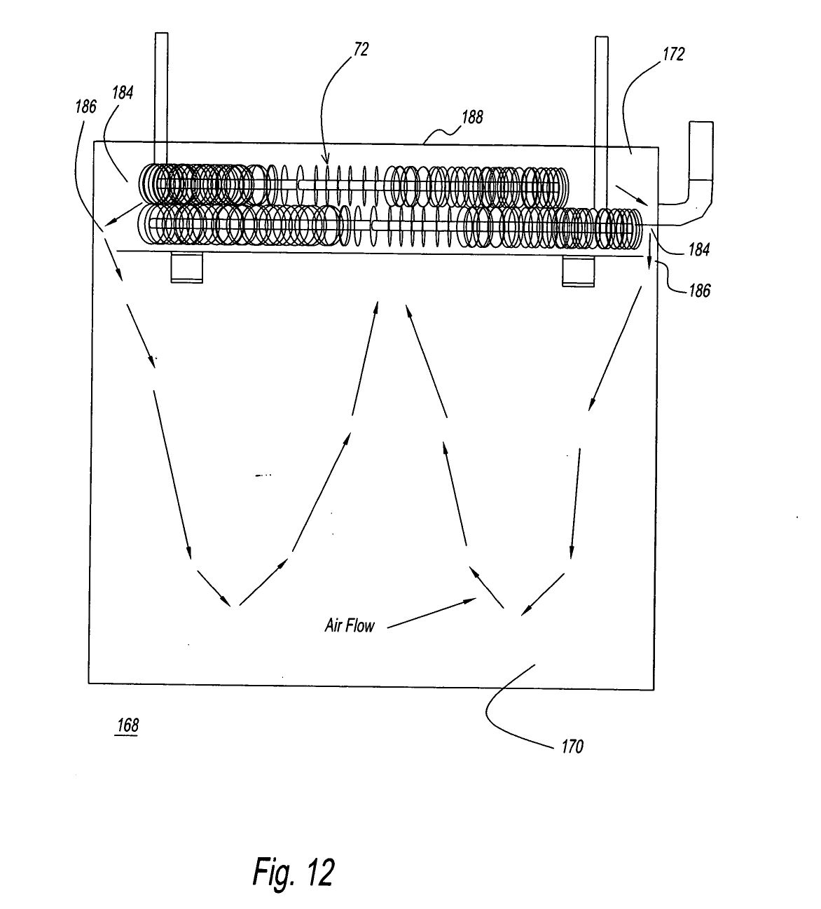

Referring to FIGS. 11 and 12, another embodiment of the oven of the present invention comprises an oven 168 that is shown with housing and door removed. Oven 168 includes a cooking chamber 170 and a heating chamber 172. Cooking chamber 170 includes a top 174, a bottom 176, a side 178 and a side 180. A front of cooking chamber 170 would be closed by a door (not shown) similar to door 36 of oven 20. A fan cover 182 separates cooking chamber 170 and heating chamber 172. An air intake port 184 is located in about the center of fan cover 182. Fan cover 182 is mounted so as to form a peripheral air gap 186 along one or more sides thereof. In the embodiment shown in FIGS. 15-17, air gap 186 extends around the entire periphery of fan cover 182 and serves as an air exhaust port. Thus, air gap 186 is located between the periphery of fan cover 182 and top 174, bottom 176, side 178 and side 180. A back 188 is spaced from fan cover 182 and fits flush with top 174, bottom 176, side 178 and side 180. Thus, heating chamber 172 is defined by fan cover 182, back 188, top 174, bottom 176, side 178 and side 180.

A heater/catalyst structure 72 is mounted to fan cover 182 so that fan 70 is aligned axially with air intake port 184. As shown in FIG. 12, heater/catalyst structure 72 is shown as heater element 160 of FIG. 10, but could be any of the embodiments of heater/catalyst structure 72.

In operation, fan 70 rotates to provide an air stream that is taken in via air intake port 184, expelled radially from fan 70 through heater catalyst structure 72 and returned to cooking chamber 170 via air gap 186. Heater/catalyst structure 72 heats and cleans the circulating air. The path of the circulating air stream is shown by the arrows in FIGS. 11 and 12.

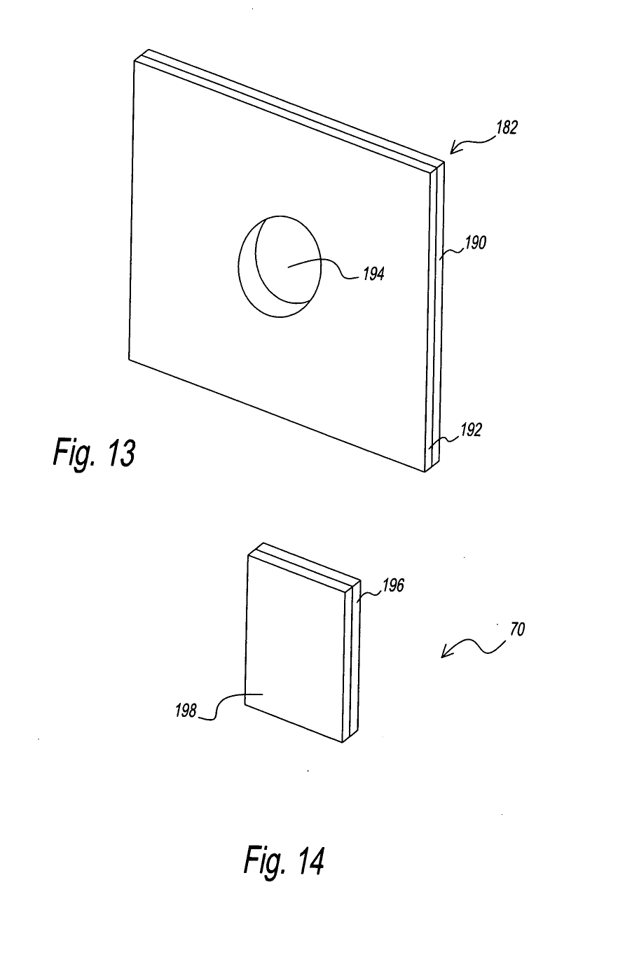

Referring to FIG. 13, fan cover 182 includes a sheet or panel 190 upon which is disposed a layer of catalytic material 192. Fan cover 182 includes a port 194. The catalytic material may also be disposed along the interior of port 194 so as to be in contact with the air stream as it is being taken in by fan 70. Panel 190 may be a metal, such as stainless steel.

Referring to FIG. 14, a blade 196 of fan 70 includes a layer of catalytic material 198. I will be appreciated that the other blades (not shown) of fan 70 may also include a layer of catalytic material 198. Catalytic material 198 is in contact with the air stream as it is being taken in by fan 70. Blade 196 may be a metal, such as stainless steel.

The present invention having been thus described with particular reference to the preferred forms thereof, it will be obvious that various changes and modifications may be made therein without departing from the spirit and scope of the present invention as defined in the appended claims.

1. A cooking device comprising:
a cooking chamber and a heating chamber connected in a fluid communication path;
a fan that circulates an air stream in said fluid communication path; and
a catalytic material disposed in close proximity to said fan to remove contaminants from said air stream.

2. The cooking device of claim 1, wherein said catalytic material is disposed about the periphery of said fan.

3. The cooking device of claim 1, wherein said fluid path extends between said cooking chamber and said heating chamber via at least one member selected from the group consisting of: side, top, bottom, and back.

4. The cooking device of claim 1, wherein said catalytic material is disposed on a structure.

5. The cooking device of claim 4, wherein said structure is selected from the group consisting of: honeycomb, laminar, fins and a plurality of air passages disposed in a plurality of layers.

6. The cooking device of claim 4, wherein said structure further includes a heater element that heats said air stream.

7. The cooking device of claim 6, wherein said heater element is elongated and includes a plurality of fins that extend outwardly, and wherein said catalytic material is disposed on said heater element.

8. The cooking device of claim 7, wherein said heater element is shaped to extend about the periphery of said fan.

9. The cooking device of claim 4, wherein said structure comprises a plurality of layers that are separated by air gaps, wherein each of said layers includes a heater element, wherein said catalytic material is disposed on at least one side of said heating element so as to face one of said air gaps, and wherein said circulating air stream flows through said air gaps and is cleansed of contaminants by said catalytic material.

10. The cooking device of claim 9, wherein said catalytic material is also disposed on an opposed side of the heating elements of said layers.

11. The cooking device of claim 9, wherein each of said layers further includes a metallic plate disposed between said at least one side of said heater element and said catalytic material.

12. The cooking device of claim 11, wherein said catalytic material is also disposed on an opposed side of said heater elements.

13. The cooking device of claim 1, further comprising a fan cover, and wherein said catalytic material is disposed on said fan cover so as to contact said air stream being taken by said fan.

14. The cooking device of claim 1, wherein said catalytic material is disposed on at least one blade of said fan.

15. A method for removing contaminants from an air stream, said method comprising:
operating a fan to circulate said air stream in a cooking device; and
disposing a catalytic material in close proximity to said fan to remove said contaminants from said air stream.

16. The method of claim 15, wherein said catalytic material is disposed on a structure that is positioned substantially in a radial flow of said air stream emitted by said fan.

17. The method of claim 16, wherein said structure is located about a periphery of said fan.

18. The method of claim 16, wherein said structure comprises a plurality of layers that are arranged in a laminar arrangement with air gaps between said layers, wherein said air gaps are substantially aligned with said radial flow, and wherein said catalytic material is disposed on at least one surface of said layers.

19. The method of claim 16, wherein said structure comprises a honeycomb arrangement that includes surfaces that define a plurality of air passages that are substantially aligned with said radial flow, and wherein said catalytic material is disposed on said surfaces.

20. The method of claim 15, further comprising the step of heating said air stream.

21. The method of claim 15, wherein said air stream circulates in a path that extends through a cooking chamber and a heating chamber of said cooking device, and wherein said fan and said catalytic material are disposed in said heating chamber.

22. The method of claim 15, wherein said catalytic material is disposed on at least one blade of said fan.

23. The method of claim 15, wherein said catalytic material is disposed on a fan cover disposed at an intake of said fan.
